(19) United States
(12) Patent Application Publication
(10) Pub. No.: US 2025/0296447 A1
(43) Pub. Date: Sep. 25, 2025

(54) METHOD PERFORMED BY A CONTROL ARRANGEMENT

(71) Applicant: Scania CV AB, Södertälje (SE)

(72) Inventors: Christian Wessel, Rönninge (SE); Casper Johansson, Hägersten (SE); Fredrik Sunden, Älvsjö (SE)

(73) Assignee: Scania CV AB, Södertälje (SE)

(21) Appl. No.: 19/075,924

(22) Filed: Mar. 11, 2025

(30) Foreign Application Priority Data
Mar. 20, 2024 (SE) 2450308-8

(51) Int. Cl. B60L 7/10

(52) U.S. Cl. CPC B60L 7/10

(57) ABSTRACT

Provided is a method and control arrangement configured to control an electrically powered vehicle, the method comprising: determining a desired total braking force to act on one or more powertrains of the electrically powered vehicle, estimating a first braking force indicative of an offered braking force to act on the one or more powertrains using characteristics of both a power storage and of a braking unit of the electrically powered vehicle, evaluating when the first braking force is greater than the offered braking force, and if so: controlling a first electric machine to generate a driving force acting on one of the one or more powertrains, the first electric machine being electrically coupled to the power storage, controlling the braking unit to generate a second braking force counteracting the driving force and acting on one of the one or more powertrains of the electrically powered vehicle.

### TECHNICAL FIELD

The present invention relates to control of electrical machines located in a vehicle.

### BACKGROUND

Vehicles, such as electrical vehicles or hybrid vehicles, that are at least partially driven or propelled by electrical machines, may also use the same electrical machines to generate braking force or braking power, sometime referred to as regenerative braking.

This is particularly important for heavy vehicles, such as trucks or busses, which are heavily relying on auxiliary brakes, e.g., when travelling downhill.

The amount of momentary regenerative braking force/momentum that an electrical machine can deliver is strongly correlated to how much charging current an electrical power storage, e.g. a battery, is capable of receiving both momentary and over time.

For how long time the electrical machine can maintain the regenerative braking force/momentum is further strongly correlated to the charging level of the power storage, sometimes referred to as State of Charge SoC.

Sometimes a heavy vehicle, such as a Battery Electric Vehicle, BEV,/hybrid truck, ends up in a situation where auxiliary braking capacity by the electrical machine/s is/are limited by the power storage. This could be caused by multiple factors, such as batteries being fully charged or having a low temperature. When regenerative braking capacity is not powerful enough, then the service brakes are typically used instead. This increases usage of the service brakes and leads to increased wear and could potentially lead to the service brakes overheating. Overheating service brakes can pose a safety hazard. Further increased wear of the service brakes triggers premature replacement of components in the service brakes, which in turn leads to decreased uptime of the vehicle and increased cost for the customer/owner of the vehicle.

Lack of regenerative braking capacity could also lead to the vehicle not fulfilling legal requirements due to poor auxiliary brake performance and therefore limiting the possible vehicle specifications of sold BEV vehicles (for example Accord Dangereux Routier, ADR, or the possibility to use a trailer).

Document US20170282896 discloses balancing of energy between power storages. However, the document does not address securing of auxiliary braking capacity.

Document US20160137092A1 discloses balancing of energy between power storages. However, the document does not address securing of auxiliary braking capacity.

Document US20200223422A1 discloses balancing of energy between power storages. However, the document does not address securing of auxiliary braking capacity.

Thus, there is a need for securing of auxiliary braking capacity in vehicles at least partially driven or propelled by electrical machines.

### OBJECTS OF THE INVENTION

An objective of embodiments of the present invention is to provide a solution which mitigates or solves the drawbacks described above.

### SUMMARY OF THE INVENTION

The above and further objectives are achieved by the subject matter described herein. Further advantageous implementation forms of the invention are described herein. The invention is set out in the appended claims.

According to a first aspect of the invention the object of the invention is achieved by a method performed by a control arrangement configured to control an electrically powered vehicle, the method comprising: determining a desired total braking force to act on one or more powertrains of the electrically powered vehicle, estimating a first braking force indicative of an offered braking force to act on the one or more powertrains using characteristics of a power storage of the electrically powered vehicle and characteristics of a braking unit of the electrically powered vehicle, evaluating when the first braking force is greater than the offered braking force, and if the evaluation is true the method further comprising the steps: controlling a first electric machine to generate a driving force acting on one of the one or more powertrains, the first electric machine being electrically coupled to the power storage, controlling the braking unit to generate a second braking force counteracting the driving force and acting on one of the one or more powertrains of the electrically powered vehicle.

The present disclosure has the advantage of improving momentary braking by controlling losses of powertrains in an innovative manner. This is achieved by carefully controlling simultaneous driving and braking of the vehicle that generates increased heat losses. The present disclosure further has the advantage of improving braking capacity over a period of time.

A further advantage is that a larger utilization of the batteries SoC window is enabled, since not as much fixed SoC margin for braking is needed. In other words, by dynamically anticipating the need for auxiliary braking, a higher SoC may be acceptable. The higher SoC enables longer range of the vehicle or a reduced need of installed battery capacity for the same range and therefore increased load carrying capacity and lower production cost of the vehicle.

In an embodiment according to the first aspect, the characteristics of the power storage include a maximum momentary current that the power storage can receive, and wherein the characteristics of the braking unit include regenerative braking force, wherein estimating the first braking force comprises matching the maximum current to a corresponding regenerative braking force using a predetermined relation.

In an embodiment according to the first aspect, the maximum current that the power storage can receive is determined based on measurements of a selection of current sensors, voltage sensors and temperature sensors coupled to the power storage.

In an embodiment according to the first aspect, the first electric machine is controlled to a first working point having a relatively low momentary braking force if a difference between the first braking force and the offered braking force is below a threshold value, or wherein the first electric machine is controlled to a second working point having a relatively high momentary braking force if a difference between the first braking force and the offered braking force is equal to or above the threshold value.

In an embodiment according to the first aspect, the desired total braking force is determined based on output from an input device controlled by a user.

In an embodiment according to the first aspect, the desired total braking force is determined based on output from a vehicle navigation module, the output from the from vehicle navigation module comprising a first brake force profile over time, wherein the first brake force profile over time is predicted using vehicle route and map data by the navigation module.

In an embodiment according to the first aspect, the characteristics of the power storage further include State of Charge of the power storage, wherein the offered braking force comprises a second brake force profile over time derived using the State of Charge of the power storage, wherein evaluating when the desired total braking force is greater than the offered braking force comprises comparing the first brake force profile over time to the second brake force profile over time.

According to a second aspect of the invention, the object of the invention is achieved by an electrically powered vehicle comprising: one or more powertrains, a control arrangement comprising a processor, and a memory, said memory containing instructions executable by said processor, a power storage configured to store electrical energy, provide electrical energy, and receive electrical energy, one or more sensors coupled to the power storage and configured to measure characteristics of the power storage, a first electric machine configured to generate a driving force acting on at least one of the one or more powertrains, the first electric machine being electrically coupled to the power storage, a braking unit configured to generate a braking force counteracting the driving force and acting on at least one of the one or more powertrains, wherein the control arrangement is communicatively coupled to the one or more sensors, the braking unit and the first electric machine, whereby said electrically powered vehicle is operative to perform the method according to the first aspect.

In an embodiment according to the second aspect, the braking unit comprises a second electric machine, the second electric machine being electrically coupled to the power storage.

In an embodiment according to the second aspect, the braking unit comprises auxiliary brakes.

In an embodiment according to the second aspect, the auxiliary brakes are selected from any one of exhaust brake, retarder, Compression Release Engine Brake.

In an embodiment according to the second aspect, the first electric machine and the braking unit are configured to act on the same one of the one or more powertrains.

In an embodiment according to the second aspect, the first electric machine and the braking unit are configured to act on different powertrains of the one or more powertrains.

According to a third aspect of the invention, the object of the invention is achieved by a control arrangement, the control arrangement comprising: a processor, and a memory, said memory containing instructions executable by said processor, whereby said control arrangement is operative to perform the method according to the first aspect.

According to a fourth aspect of the invention, the object of the invention is achieved by a computer program comprising instructions which, when the program is executed by a computer, cause the computer to carry out the method according to the first aspect.

According to a fifth aspect of the invention, the object of the invention is achieved by a computer-readable medium comprising instructions which, when executed by a computer, cause the computer to carry out the method according to the first aspect. The scope of the invention is defined by the claims, which are incorporated into this section by reference. Reference will be made to the appended sheets of drawings that will first be described briefly.

### BRIEF DESCRIPTION OF THE DRAWINGS

FIG. 1A shows a side view of an electrically powered vehicle according to one or more embodiments of the present disclosure.

FIG. 1B shows a top view of the electrically powered vehicle according to one or more embodiments of the present disclosure.

FIG. 2 shows details of the electrically powered vehicle according to one or more embodiments of the present disclosure.

FIG. 3 shows details of the electrically powered vehicle according to one or more embodiments of the present disclosure.

FIG. 4 illustrates the operation of the method according to one or more embodiments of the present disclosure.

FIG. 5 shows a further example of operation of the method according to one or more embodiments of the present disclosure.

FIG. 6 illustrates working points of an electrical machine according to one or more embodiments of the present disclosure.

FIG. 7 Illustrates a first scenario of selected working points for an electrical machine.

FIG. 8 Illustrates a second scenario of selected working points for an electrical machine.

FIG. 9A-C illustrates prediction of a brake profile according to one or more embodiments of the present disclosure.

FIG. 10A-B illustrates generation of an offered braking force profile.

FIG. 11 illustrates a flowchart of a method according to one or more embodiments of the present disclosure.

FIG. 12 shows a control arrangement according to one or more embodiments of the present disclosure.

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figures.

### DETAILED DESCRIPTION

The present disclosure relates to control of electrical machines in vehicles, such as electrical vehicles or hybrid vehicles, that are at least partially driven or propelled by electrical machines. The same electrical machines may typically be used to generate auxiliary braking force or power, sometime referred to as regenerative braking.

An electrical machine requires a particular electrical current to be provided, e.g., by a power storage, in order for the electrical machine to provide a desired driving/propelling force, momentum or torque. In a similar manner, the electrical machine requires a particular electrical current to be received, e.g., by a power storage, in order for the electrical machine to provide a desired braking force, momentum or torque. In other words, the electrical machine acts as a motor consuming current to drive the vehicle, and acts as a generator providing current when providing regenerative braking.

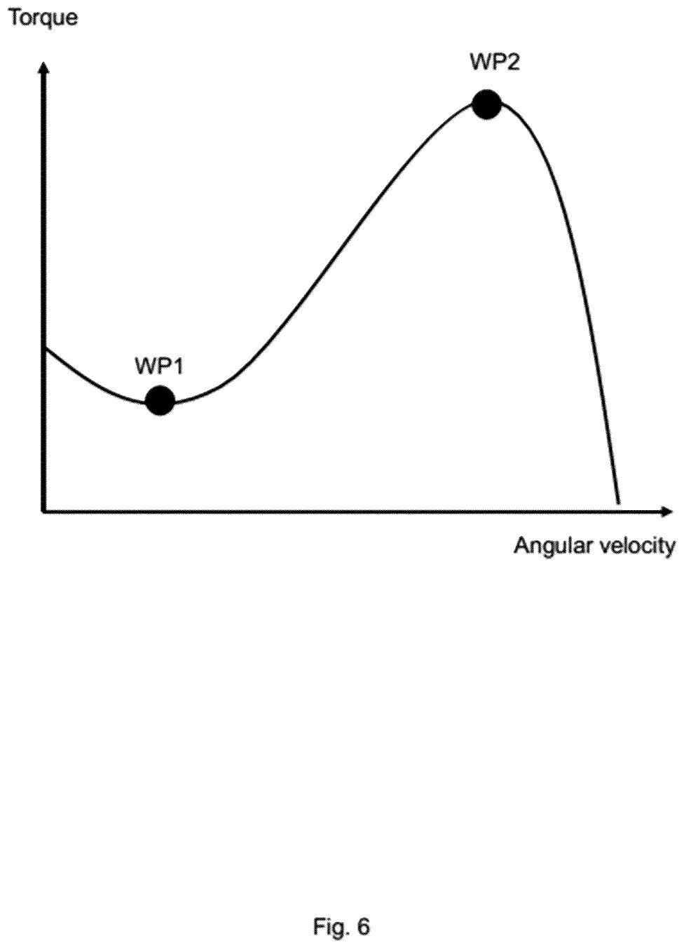

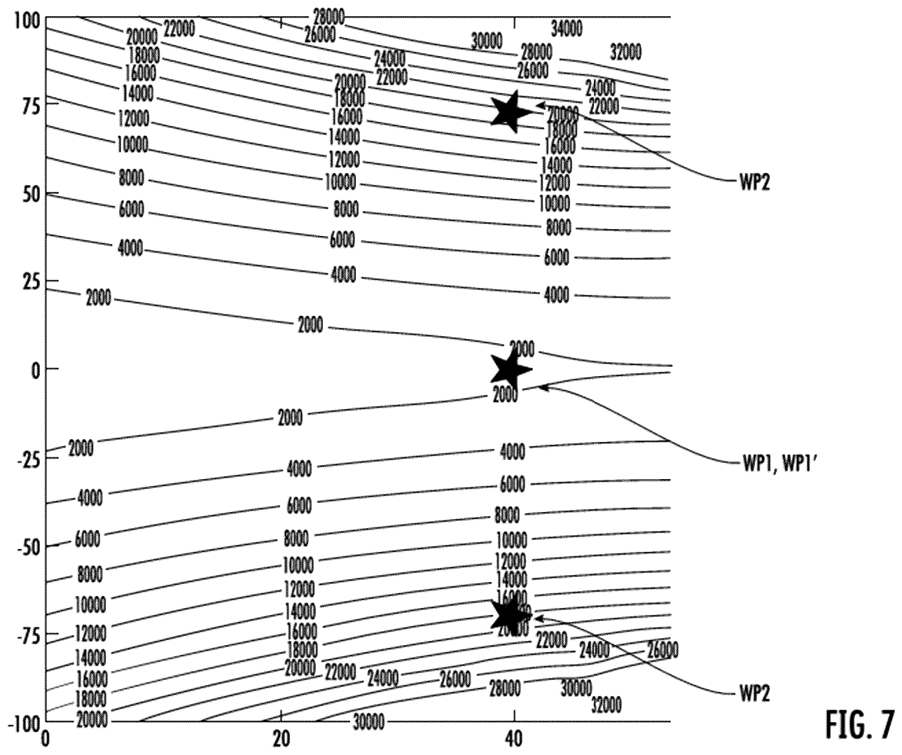

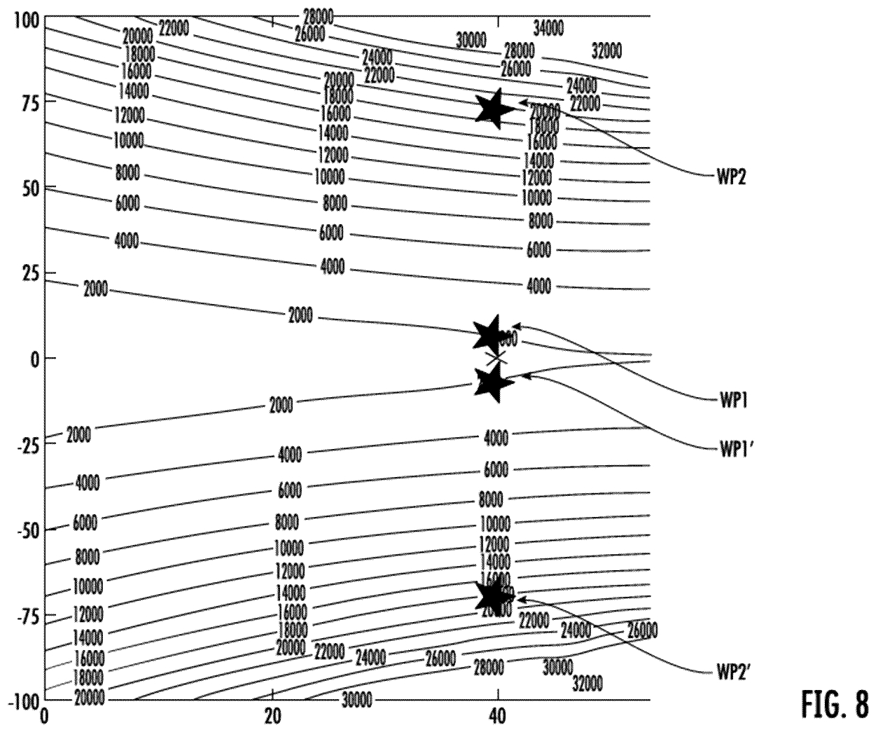

In other words, the performance of the electrical when providing regenerative braking power may be limited by the power storage. The extent that the power storage will limit braking power depends on a selected working point of the electrical machine, as further described in relation to FIG. 6, FIG. 7 and FIG. 8.

The capability of a power storage, such as a battery, to provide/receive current or energy is dependent on various characteristics of the power storage.

One important characteristic for momentary capacity to provide/receive current is internal impedance/resistance of the power storage, which will vary e.g., with the temperature of the power storage, the health of the power storage and the charging level of the power storage.

One further important characteristic for capacity over a period of time to receive current is the charging level, often described as State of Charge, SoC. When the power storage is fully charged, or nearly fully charged, typically near 100% SoC, both the momentary capacity to provide/receive current and the capacity over a period of time to provide/receive current is then limited.

When using an electric machine coupled to one or more powertrains of the vehicle to provide auxiliary braking, then the auxiliary braking capacity is limited by the momentary capacity to provide/receive current and by the capacity over a period of time to provide/receive current of the power storage. In other words, the power storage may reach a charging level where no more energy may be stored.

The present disclosure improves auxiliary braking capacity by controlling heat loss in the powertrain and by improving the limitations the power storage to the electrical machine/s. The present disclosure does this by evaluating if a desired total braking force is greater than an offered braking force. If the evaluation is true, the method further comprises the steps of controlling a first electric machine to generate a driving force acting on one of the one or more powertrains, the first electric machine being electrically coupled to the power storage. Further, controlling a braking unit to generate a braking force counteracting the balanced driving force and acting on one of the one or more powertrains of the electrically powered vehicle.

In this disclosure the term braking unit denotes a unit configured to provide braking force, torque or power to a vehicle or a powertrain of a vehicle. Examples of braking units may be an electrical machine, an exhaust brake, a retarder, a Compression Release Engine Brake, CRB.

In other words, when two electrical machines, either through two or more mechanically separated powertrains or in the same powertrain, operate in a vehicle there is a possibility to exert power between them. This is done by performing regenerative braking with one electric machine, thus acting as a breaking unit, and propel the vehicle/consume electric power with the other. All this with the net added force acting on the vehicle being 0 N. Due to the fact that powertrain/s do not have a 100% efficiency, this creates an operational mode that effectively consumes energy from the power storage, e.g., a vehicle/battery, and uses it to auxiliary brake the vehicle.

This functionality is not limited to only using two electrical machines acting against each other but at least one is needed to draw current from the power storage to propel the vehicle. That force could be countered by any actuator, for example conventional auxiliary brakes such as exhaust brake, Retarder, Compression Release Engine Brake, CRB etc., that can create a net force of 0 N on the vehicle.

As mentioned, the present disclosure has the advantage of improving momentary braking by controlling losses of powertrains in an innovative manner. This is achieved by carefully controlling simultaneous driving and braking of the vehicle that generates increased heat losses. The increased heat losses are further used to heat a power storage of the vehicle. The power storage is typically in the form of a battery, and heating of the battery increases the capacity to receive electrical currents, e.g., by reduced internal impedance/resistance. This in turn leads to increased momentary auxiliary braking power thereby unlocking the full potential of the electrical machine and the vehicle's auxiliary braking power.

If the battery is cold, heating of the battery increases the capacity to receive electrical currents, e.g., by reduced internal impedance/resistance. This in turn leads to increased momentary auxiliary braking power thereby unlocking the full potential of the electrical machine and the vehicle's auxiliary braking power.

The present disclosure further has the advantages of improving capacity over a period of time to receive current. Since the added net force on the vehicle is 0 N, the functionality can be activated at any time during driving, and if used in combination with map data it could be run preemptively to reduce the SOC of the batteries. For example, in order to have sufficient braking capacity in a hill further down the road.

A further advantage is that a larger utilization of the batteries SoC window is enabled, since not as much fixed SoC margin for braking is needed. In other words, by anticipating the need for auxiliary braking, a higher SoC may be acceptable. This in turn enables longer range of the vehicle or a reduced need of installed battery capacity for the same range and therefore increased load carrying capacity and lower production cost of the vehicle.

In the present disclosure the terms driving force, driving power, or driving momentum are used interchangeable and defines linear or angular energy that acts to propel the electrically powered vehicle 100 in a desired direction.

In the present disclosure the terms braking force, braking power or braking momentum are used interchangeable and defines linear or angular energy that acts to reduce movement of the electrically powered vehicle 100.

In the present disclosure the term “powertrain” typically include all components from the power source to the driving wheels. An electrical or hybrid vehicle may comprise multiple drivetrains, each with a separate power source, such as an electrical machine.

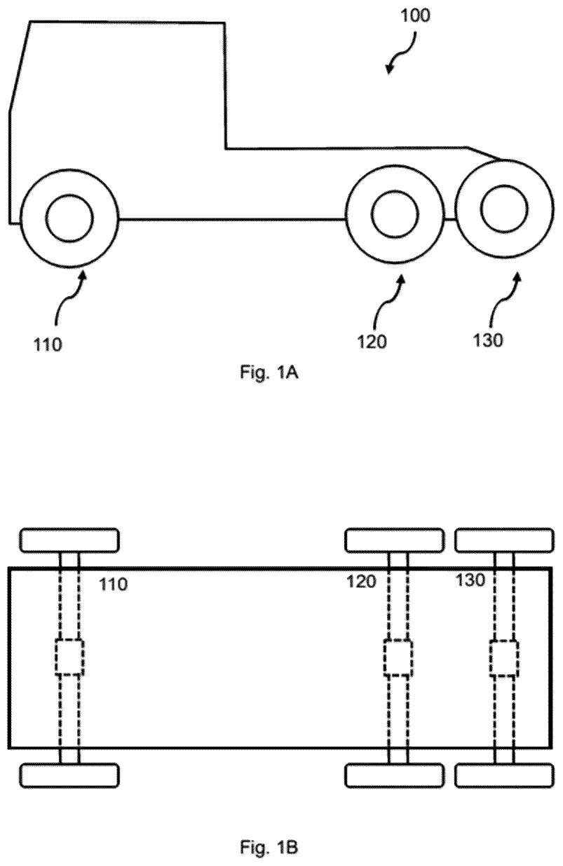

FIG. 1A shows a side view of an electrically powered vehicle 100 according to one or more embodiments of the present disclosure. FIG. 1A shows the electrically powered vehicle 100 having three separate powertrains, where one powertrain 110 is at the front of the vehicle and two powertrains 120, 130, are located at the back end of the vehicle.

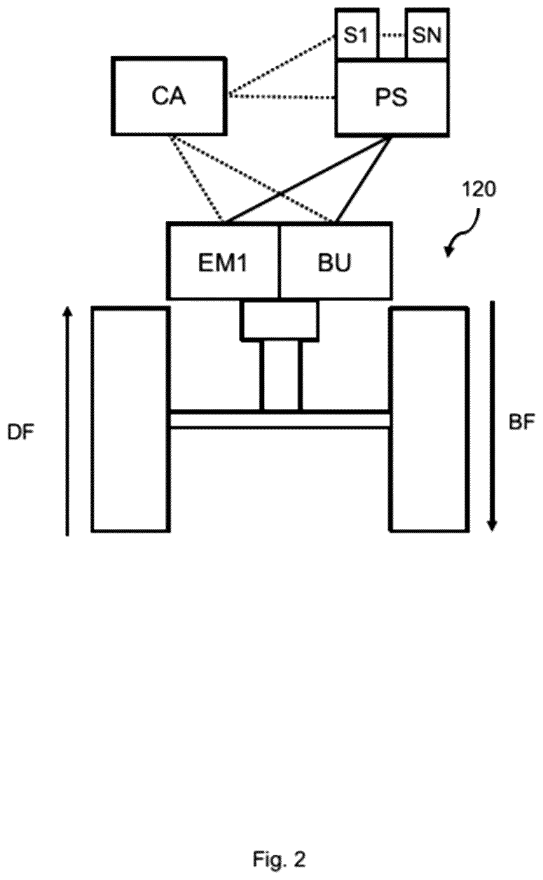

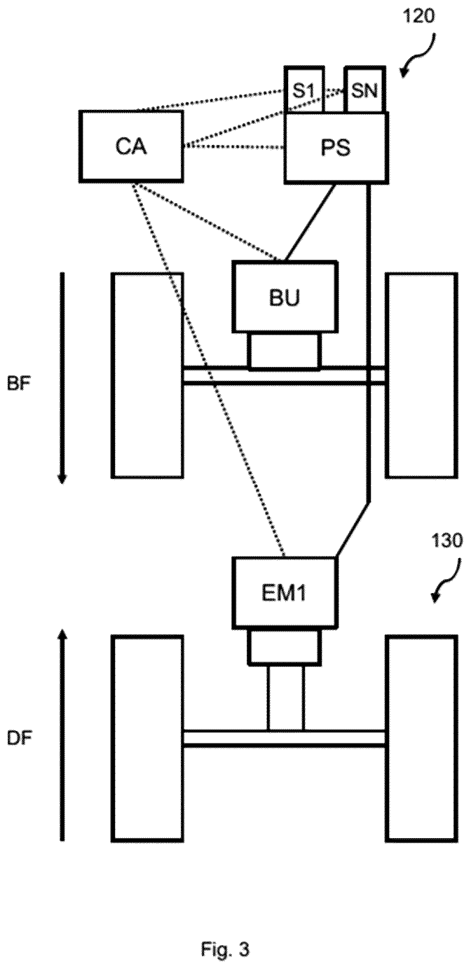

It is understood that any suitable configuration of powertrains could be used and is further described in relation to FIG. 2 and FIG. 3.

FIG. 1B shows a top view of the electrically powered vehicle 100 according to one or more embodiments of the present disclosure. FIG. 1B shows the electrically powered vehicle 100 having three separate powertrains, where one powertrain 110 is located at the front end (left hand side of the figure) of the vehicle and two powertrains 120, 130, that are located at the back end of the vehicle.

According to an aspect of the present disclosure, an electrically powered vehicle 100 is provided and comprises:
one or more powertrains 110, 120, 130,
a control arrangement CA comprising a processor, and a memory, said memory containing instructions executable by said processor,
a power storage PS configured to store electrical energy, provide electrical energy, and receive electrical energy,
one or more sensors coupled to the PS and configured to measure characteristics of the PS,
a first electric machine EM1 configured to generate a driving force DF acting on at least one of the one or more powertrains 110, 120, 130, the EM1 being electrically coupled to the PS,
a braking unit BU configured to generate a braking force BF counteracting the DF and acting on at least one of the one or more powertrains 110, 120, 130,
wherein the CA is communicatively coupled to the one or more sensors, the BU and the EM1,
whereby said electrically powered vehicle 100 is operative to perform the method described herein.

Additionally, or alternatively, the BU comprises a second electric machine EM2, the EM2 being electrically coupled to the PS.

Additionally, or alternatively, the BU comprises auxiliary brakes.

Additionally, or alternatively, the auxiliary brakes are selected from any one of exhaust brake, retarder, Compression Release Engine Brake.

Additionally, or alternatively, the EM1 and the BU are configured to act on the same one of the one or more powertrains 110, 120, 130. This is further illustrated in FIG. 2.

Additionally, or alternatively, the EM1 and the BU are configured to act on different powertrains of the one or more powertrains 110, 120, 130. This is further illustrated in FIG. 3.

Additionally, or alternatively, the EM1 and/or the PS and/or the BU are thermally coupled. In one example, the EM1, the PS and the BU are fluidly coupled to the same cooling system. This means that when the EM1 and/or BU experience heat loss, this will effectively heat the PS via the cooling system.

FIG. 2 shows details of the electrically powered vehicle 100 according to one or more embodiments of the present disclosure. FIG. 2 shows top view of a configuration of the vehicle where the electrically powered vehicle 100 comprises at least a first electric machine EM1 and a braking unit BU acting on the same drivetrain 120 on the vehicle.

The EM1 is configured to generate a driving force, driving power, or driving momentum DF acting on the more powertrain 120. The driving force, driving power or driving momentum DF acts to propel the electrically powered vehicle 100 in a desired direction.

It is understood that a plurality of electric machines may be used to generate additional driving force without departing from the present disclosure. In one example, the EM1 is operating on one powertrain to implement the present disclosure and simultaneously one or more power sources are providing additional drive force, e.g. to maintain a target speed of the electrically powered vehicle 100.

The BU is configured to generate a braking force, braking power or braking momentum BF acting on the powertrain 120. The braking force, braking power or braking momentum BF acts to reduce movement/speed of the electrically powered vehicle 100 and effectively counteracts the driving force DF.

It is understood that a plurality of BUs may be used to generate additional braking force without departing from the present disclosure. The BU may comprise an electric machine or conventional auxiliary brakes such as exhaust brake, Retarder, Compression Release Engine Brake, CRB etc.

In one example, the BU is operating on one powertrain 120 to implement the present disclosure and simultaneously one or more other BUs are providing additional braking force, e.g. in a very steep descent or when a BU comprising an electrical machine is not providing sufficient braking force.

The electrically powered vehicle 100 further comprises a CA comprising a processor, and a memory, said memory containing instructions executable by said processor causing the processor to perform the methods described herein.

The electrically powered vehicle 100 further comprises a PS configured to store electrical energy, provide electrical energy, and receive electrical energy and is typically a battery or battery pack.

The electrically powered vehicle 100 further comprises one or more sensors S1-SN coupled to the PS and configured to measure characteristics of the PS and/or the vehicle 100. Optionally the electrically powered vehicle 100 further comprises additional sensors (not shown), such as vehicle velocity sensors configured to measure vehicle velocity, vehicle load sensors configured to measure load carried by the vehicle or vehicle location sensor/s and associated maps configured to measure location/velocity/direction/altitude of the vehicle. The vehicle location sensor/s, e.g., a Global Positioning System unit (GPS), is typically part of a navigation system of the electrically powered vehicle 100.

The EM1 is electrically coupled to the PS, illustrated by a solid line. Optionally one or more BUs comprises a second electric machine EM2 and is electrically coupled to the PS, also illustrated by a solid line.

As mentioned previously, the EM1, the PS and the BU may be fluidly coupled to the same cooling system. This means that when the EM1 and/or BU experience heat loss, this will effectively heat the PS via the cooling system.

The CA is communicatively coupled to the one or more sensors S1-SN, the BU and the EM1. Optionally, the CA is communicatively coupled to the PS.

FIG. 3 shows details of the electrically powered vehicle 100 according to one or more embodiments of the present disclosure. FIG. 3 shows top view of a configuration of the vehicle 100 where the electrically powered vehicle 100 comprises an EM1 that is acting on a first drivetrain 130 and a BU that is acting on a second drivetrain 120 on the vehicle.

In other words, the first and second drivetrain is not mechanically coupled, rather they can be seen as being “connected” by the ground on which the vehicle 100 stands. The wheels of the respective drivetrain 120, 130 is coupled by friction of the tires to the ground and thereby to each other, even though some slippage may occur.

In other respects, the units are communicatively coupled and/or electrically coupled in the same manner as described in relation to FIG. 2.

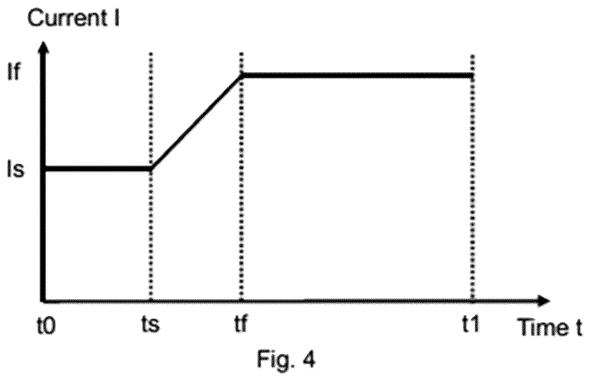

In the present disclosure, situations where the PS limits the capacity of the BU are improved, which is illustrated in FIG. 4.

FIG. 4 illustrates the operation of the method according to one or more embodiments of the present disclosure. The figure shows a diagram with current I on the vertical axis and time t on the horizontal axis. The current is the maximum momentary current the PS is capable to receive under certain operational conditions.

The diagram shows current I for a time period from a first point in time t0 to a second point in time t1. Control according to the present disclosure of the EM1 and BU is active from a third point in time ts to a fourth point in time tf.

In FIG. 4 the momentary capacity of the PS to receive current/charging current I before operating the method is shown as Is. In FIG. 4 the momentary capacity of the PS to receive current/charging current I after operating the method is shown as If.

In one example, electrical current/charging current is optionally received by the PS from the BU comprising a second electrical machine EM2.

At time t0, a desired total braking force DTBF is determined, to act on one or more powertrains 120, 130 of the electrically powered vehicle 100.

After time t0 and before time ts, an offered braking force OBF is estimated to act on the one or more powertrains 110, 120, 130. The OBF is determined using at least characteristics of the PS of the electrically powered vehicle 100 and characteristics of a BU of the electrically powered vehicle 100.

In this example, the characteristics of the PS include temperature of the PS, typically the temperature of a battery, and optionally a charging level/State Of Charge, SoC, of the battery.

The characteristics of the BU may include a first predetermined relation between generated braking force and generated current by the BU. This first predetermined relation is typically provided by the manufacturer of the BU or can be measured in a lab.

In a similar manner the characteristics of the EM1 may include a similar predetermined relation between provided electric current and generated driving force by the EM1.

The relation between generated electric current and generated braking force/driving force will depend on a working point of the electrical machine being selected. In other words, a working point comprising a particular angular velocity or speed of the electrical machine and a torque of the electrical machine is selected. Each working point will be associated with a particular heat loss. This means that the heat loss of the system may be varied or controlled by selecting a working point. This predetermined relation is typically provided by the manufacturer of the BU/EM1/EM2 or can be measured in a lab.

Selection of working points is further described in relation to FIG. 6, FIG. 7, and FIG. 8.

Using the temperature of the PS and/or the SoC of the PS, a current I can be derived from a second predetermined relation that takes temperature and/or the SoC as input and provides a current I as output. This second predetermined relation may e.g., be a Look Up Table, LUT. In the diagram this output is shown as Is.

By applying the current Is to the first predetermined relation and selecting a working point, an offered braking force OBF can be obtained, e.g., as a braking momentum or torque.

It is then evaluated when the DTRF>OBF, and if the evaluation is true then further steps are taken during a time period at from the third point in time ts to the fourth point in time tf.

The EM1 is controlled by the CA to generate a driving force DF acting on one of the one or more powertrains 110, 120, 130. As the EM1 is electrically coupled to the PS, energy or a current is drawn from the PS.

The BU is simultaneously controlled to generate a braking force BF counteracting the driving force DF and acting on one of the one or more powertrains 110, 120, 130 of the electrically powered vehicle 100. As shown in FIG. 2 and FIG. 3, the EM1 and the BU act on the same power train or on different powertrains on the same vehicle 100.

The driving force DF and the braking force BF are substantially the same, or in practical circumstances the same. This means that a net force N=0 is applied to the vehicle. In other words, the movement of the vehicle 100 will not be affected and/or the speed of the vehicle 100 will not be affected.

The operation of the EM1, the operation of the BU and corresponding current provided and received by the PS generates heat and increases the temperature of the PS. This is due to the fact that at least the PS and the BU are thermally connected, e.g. coupled to the same cooling/heating system. Typically, the SoC of the PS is also lowered. This will increase temperature of the PS and/or lower the charging level of the PS.

These changes will in turn improving momentary capacity of the PS to receive current, and in cases where this limits the braking force capacity of the BU, also improve momentary auxiliary braking capacity or regenerative braking capacity.

In other words, unlocking the full potential of the electrical machine and the vehicle's auxiliary braking power.

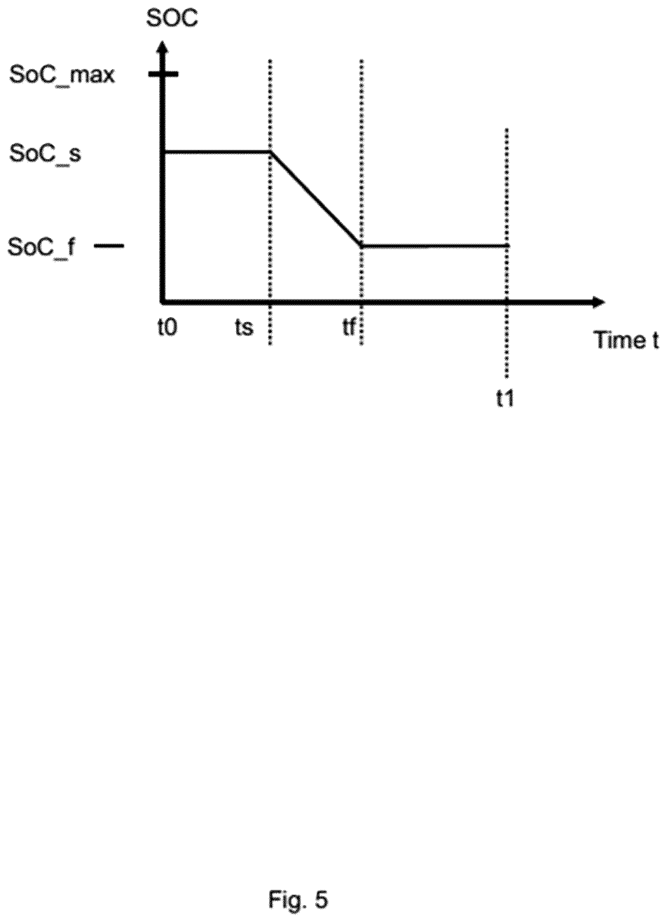

FIG. 5 shows a further example of a method according to one or more embodiments of the present disclosure. The figure shows a diagram with SoC of the PS on the vertical axis and time t on the horizontal axis.

In the diagram, a charging capacity SoC_max of the PS is shown. SoC_max typically correspond to 100% SoC. The figure further shows a current SoC shown as SoC_s which indicates the current charging level before operation of the disclosed method and under certain operational conditions. The figure further shows a resulting SoC shown as SoC_f which indicates the charging level of the PS after operation of the disclosed method.

The diagram shows SoC of the PS from a first point in time t0 to a second point in time t1. Control of the EM1 and BU is active from a third point in time ts to a fourth point in time tf.

This reduction in SoC will change characteristics of the PS. These changes will in turn improve momentary capacity of the PS to receive current and also improve capacity of the PS to receive current over time. In cases where the capacity of the PS limits the braking force capacity of the BU, this also improves momentary auxiliary braking capacity or regenerative braking capacity as well as auxiliary braking capacity or regenerative braking over time.

In other words, unlocking the full potential of the electrical machine and the vehicle's auxiliary braking power.

In one example, when the SoC of the PS is lowered then the internal resistance of the PS is changed which will affect momentary capacity of the PS.

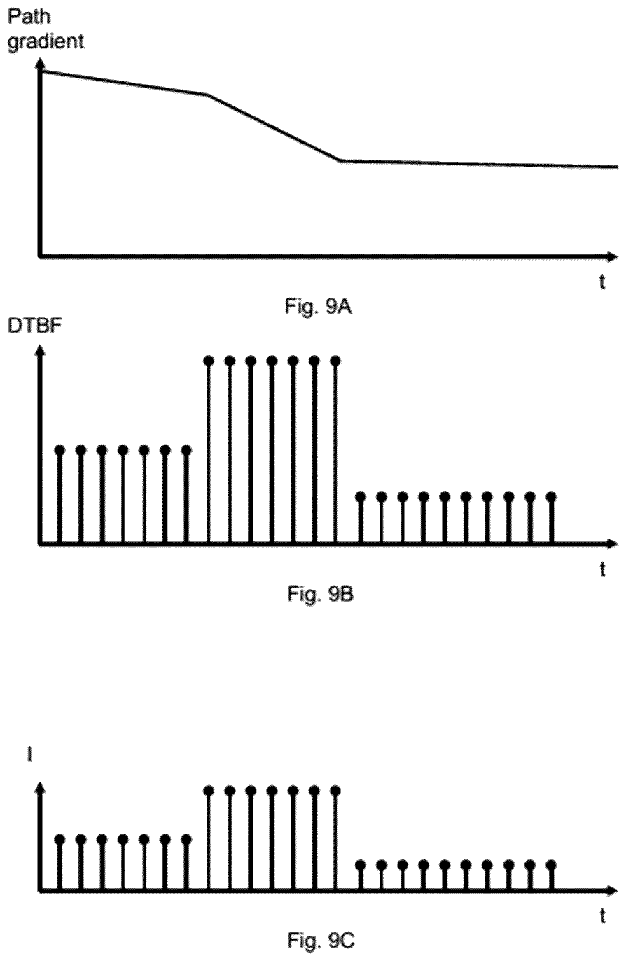

In one further example, the DTBF is determined as a braking force of x Newton over a time of 20 minutes and indicated by a predicted braking force profile. Using the first predetermined relation, a corresponding current profile can be determined, as illustrated in FIG. 9C. Using the current profile, the auxiliary braking regenerative braking capacity over time can be determined and a corresponding target SoC. The target SoC may be determined by applying coulomb counting methods to the current profile, as further described in relation to FIG. 8A-B. In this manner, the PS capacity to receive current over a period of time is improved.

FIG. 6 illustrates working points of an electrical machine according to one or more embodiments of the present disclosure. FIG. 6 illustrates a simplified diagram of a predetermined relation.

The electrical machines EM1, EM2 of the electrically powered vehicle 100 can be controlled to operate in different working points, as illustrated by the diagram in FIG. 6. Each working point will further be associated to a particular heat loss. Heat loss is further illustrated in relation to FIG. 7. The angular velocity of the electrical machine may be varied and/or controlled, e.g., by a planetary gear and/or gearbox coupled to the powertrain. Depending on the angular velocity of shafts of the electrical machines EM1, EM2, different braking force or braking torque will be generated. The braking torque is then related to the generated electric current, as described previously.

FIG. 6 shows a first working point WP1 of an electric machine EM1 having a relatively low momentary braking force and is operating at a relatively low angular velocity.

FIG. 6 further shows a second working point WP2 of EM1 having a relatively high momentary braking force and operating at a relatively high angular velocity.

The working points WP1 and WP2 are associated with different heat loss.

In one embodiment, the EM1 is controlled to a first working point WP1 having a relatively low momentary braking force/generated current at a relatively low angular velocity if a difference between the first braking force and the offered braking force. OBF, is below a threshold value. Additionally, or alternatively. the EM1 is controlled to a second working point WP2 having a relatively high momentary braking force if a difference between the first braking force and the offered braking force OBF is equal to or above the threshold value.

FIG. 7 Illustrates a first scenario of selected working points for an electrical machine. In this scenario the BU is in the form of EM2. The working points are illustrated as stars in the figure.

FIG. 7 shows normalized torque from +100% to −100% on the vertical axis and normalized angular speed/velocity from 0% to 50% on the horizontal axis. The lines illustrate heat loss at different working points.

In this scenario, DTBF is predicted for an upcoming downhill/descent in a planned path.

With reference to FIG. 5, for time t0 to ts, the working point for BU WP1′ and the working point for EM1 WP1 is selected to 0% torque, thereby generating a heat loss of 2000+2000 W.

For time ts to tf, the working point for BU WP2′ is selected to −75% and the working point for EM1 WP2 is selected to 75% torque, thereby generating a heat loss of 20 kW+18 kW=38 kW. Thereby the SoC can be lowered to accommodate the energy over time generated by the DTBF.

FIG. 8 Illustrates a second scenario of selected working points for an electrical machine. In this scenario the BU is in the form of EM2. The working points are illustrated as stars in the figure.

FIG. 8 shows normalized torque from +100% to −100% on the vertical axis and normalized angular speed/velocity from 0% to 50% on the horizontal axis. The lines illustrate heat loss at different working points.

In this scenario, the SoC of the PS limits the capability to receive energy to 30 kW. It can be assumed that this can generate −25% torque, or braking torque, at an angular speed/velocity of 40%.

With reference to FIG. 5, for time t0 to ts, the working point for BU WP1′ and the working point for EM1 EP1 is both selected to −12.5% torque, thereby generating a heat loss of 2000+2000 W. Total available braking energy is then 34 kW.

For time ts to tf, the working point for BU WP2′ is selected to −100% and the working point for EM1 WP2 is selected to 75% torque, thereby generating a heat loss of 20 kW+32 kW=52 kW. Total available braking energy is then 82 kW.

FIG. 9A-C illustrates prediction of a brake profile according to one or more embodiments of the present disclosure.

FIG. 9A shows a diagram with gradient of a planned path on the vertical axis and time on the horizontal axis. A navigation unit may e.g., plan a path or route that the electrically powered vehicle 100 is to follow. On that path, a section of the path comprises a descent with varying gradient, as illustrated in the diagram in FIG. 9A. Using characteristics of the planned path, such as speed limits, and total weight of the electrically powered vehicle 100, a DTBF can be predicted as a braking force profile.

FIG. 9B illustrates a predicted braking force profile DTBF. FIG. 9B shows a bar diagram with predicted momentary braking forces over time. In other the diagram shows predicted momentary braking forces at different points in time.

FIG. 9C illustrates a current profile. Using the first predetermined relation between generated braking force and generated current, further described in relation to FIG. 4, the momentary desired current, for a particular working point, generated by the respective electrical machine/BU/EM2 can be derived.

The predicted brake profile may both be used to determine a required momentary current and to ensure that the PS has a SoC that will allow the PS to receive momentary current over time defined by the predicted current profile shown in FIG. 9C.

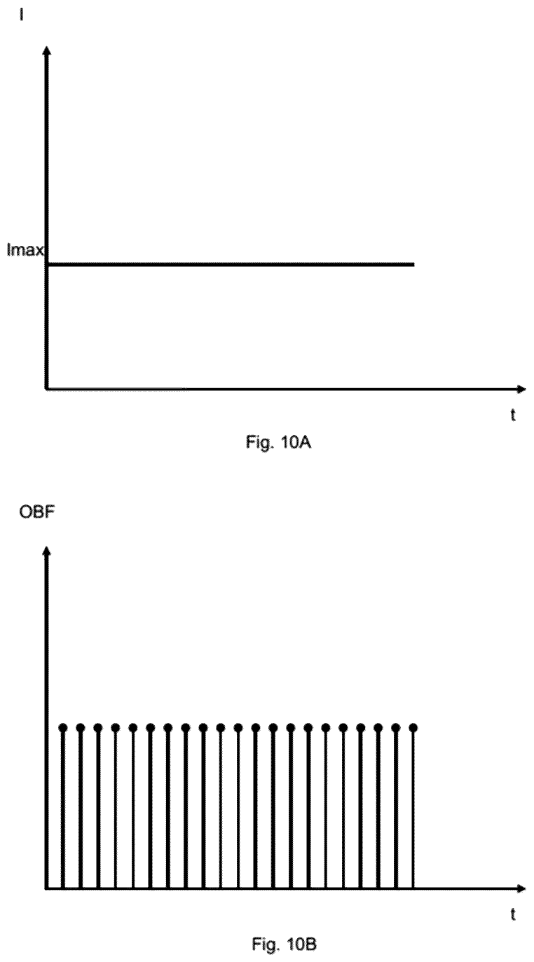

FIG. 10A-B illustrates generation of an offered braking force profile.

FIG. 10A shows a first step in the generation of an offered braking force profile.

Using the characteristics of the PS, such as temperature, a momentary current value Imax may be derived, as previously described in relation to FIG. 4, by using the second predetermined relation. Further a working point with an associated heat loss is selected. A current profile may be then generated by repeating the Imax for all points in time corresponding to the predicted braking force profile described in relation to FIG. 9A-C.

The current profile may then be used to generate the offered braking force profile, as previously described in relation to FIG. 4, by using the first predetermined relation to obtain corresponding braking force values.

FIG. 10B illustrates an offered braking force profile. As can be seen in FIG. 10B, offered momentary braking force values over time form the offered braking force profile.

In one example, a single value from the profile shown in FIG. 9B may be selected as DTBF. Using the characteristics of the PS, such as temperature, a maximum current value may be derived using the second predetermined relation, as previously described in relation to FIG. 4, to obtain OBF. The DTBF and the OBF may then be used in the evaluation of the method.

In one further example, the momentary braking force values of the predicted profile in FIG. 9B may be integrated for a period of time to form a total value or area under the curve used as DTBF. The offered braking force profile, shown in FIG. 10B may be integrated over the same period of time as the predicted braking force profile in FIG. 9B to form a total value or area under the curve and used as OBF. The DTBF and the OBF may then be used in the evaluation of the method.

In one further example, the characteristics of the PS comprises current SoC and maximum charging capacity. A target SoC may then be determined by performing conventional coulomb counting methods on the current profile shown in FIG. 9C and relating the result of the coulomb counting to the current SoC and/or the maximum charging capacity. The target SoC and the current SoC can then be used as DTBF and OBF respectively.

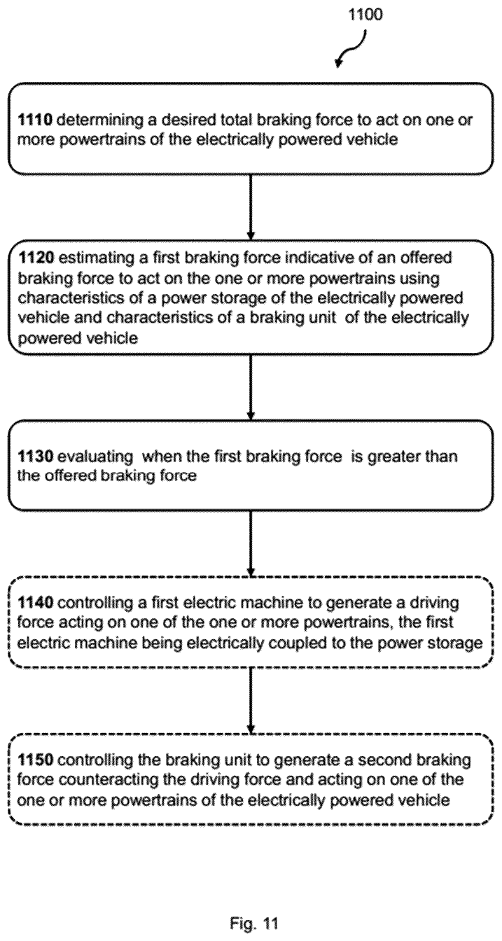

FIG. 11 illustrates a flowchart of a method 1100 according to one or more embodiments of the present disclosure. The method is performed by a control arrangement CA configured to control an electrically powered vehicle 100. The method comprises:

Step 1110: determining a desired total braking force DTBF to act on one or more powertrains 110, 120, 130, of the electrically powered vehicle 100.

Determining DTBF is further described in relation to FIG. 9A-C.

Step 1120: estimating a first braking force indicative of an offered braking force OBF to act on the one or more powertrains 110, 120, 130 using characteristics of a power storage PS of the electrically powered vehicle 100 and characteristics of a braking unit BU of the electrically powered vehicle 100.

Estimating OBF is further described in relation to FIG. 10A-B.

Step 1130: evaluating when the first braking force DTBF is greater than the offered braking force OBF. The DTBF and the OBF may in embodiments comprise single brake force values or a brake force profile comprising a plurality of brake force values.

If the evaluation of step 1130 is true, the method further comprises the steps:

Step 1140: controlling a first electric machine EM1 to generate a driving force DF acting on one of the one or more powertrains 110, 120, 130, the first electric machine EM1 being electrically coupled to the power storage PS.

Step 1150: controlling the braking unit BU to generate a second braking force BF counteracting the driving force DF and acting on one of the one or more powertrains 110, 120, 130 of the electrically powered vehicle 100.

Additionally, or alternatively, the characteristics of the power storage PS include a momentary maximum current that the power storage PS can receive, and wherein the characteristics of the braking unit BU include regenerative braking force, wherein estimating the offered braking force OBF comprises matching the momentary maximum current to a corresponding regenerative braking force using a predetermined relation. Matching the momentary maximum current to a corresponding regenerative braking force is further detailed in relation to FIG. 4.

Additionally, or alternatively, the maximum current that the power storage PS can receive is determined based on measurements of a selection of current sensors, voltage sensors and temperature sensors coupled to the power storage PS.

As previously described in relation to FIG. 4, by using the temperature of the PS and/or the SoC of the PS, a maximum current is derived from a second predetermined relation that takes temperature and/or the SoC as input and provides a maximum current I as output.

Additionally, or alternatively, the first electric machine EM1 is controlled to a first working point WP1 having a relatively low momentary braking force BF if a difference between the first braking force and the offered braking force OBF is below a threshold value, or

wherein the first electric machine EM1 is controlled to a second working point WP2 having a relatively high momentary braking force BF if a difference between the first braking force and the offered braking force OBF is equal to or above the threshold value.

Controlling an electric machine to a working point is further described in relation to FIG. 6, FIG. 7 and FIG. 8.

Additionally, or alternatively, the desired total braking force DTBF is determined based on output from an input device controlled by a user. The input device may e.g., be configured to receive special movements, speech, or text input. Examples of input devices are pedals, levers, touch screens and microphones.

Additionally, or alternatively, the desired total braking force DTBF is determined based on output from a vehicle navigation module, the output from the from vehicle navigation module comprising a first brake force profile over time, wherein the first brake force profile over time is predicted using vehicle route and map data by the navigation module.

Determining DTBF is further described in relation to FIG. 10A-C.

Additionally or alternatively, the characteristics of the power storage PS further include State of Charge SoC of the power storage PS, wherein the offered braking force OBF comprises a second brake force profile over time derived using the State of Charge SoC of the power storage PS, wherein evaluating when the DTRF is greater than the OBF comprises comparing the first brake force profile over time to the second brake force profile over time.

Determining OBF is further described in relation to FIG. 10A-B.

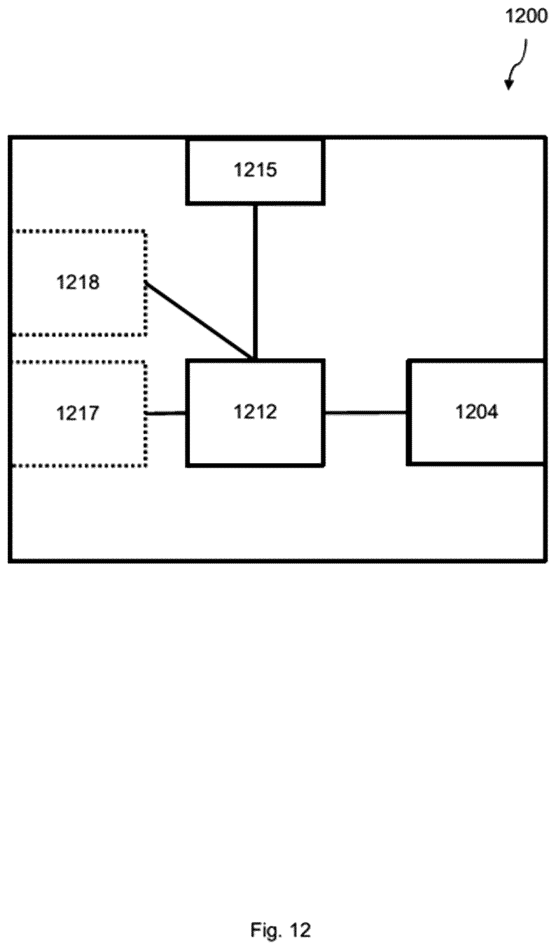

FIG. 12 shows a control arrangement 1200 according to one or more embodiments of the present disclosure. The control arrangement 1200 may e.g., be in the form of an Electronic Control unit, a server, an on-board computer, a vehicle mounted computer system or a navigation device. The control arrangement 1200 may comprise a processor or processing means 1212 communicatively coupled to a transceiver 1204 configured for wired or wireless communication. Further, the control arrangement 1200 may further comprise at least one optional antenna (not shown in figure). The antenna may be coupled to the transceiver 1204 and is configured to transmit and/or emit and/or receive wireless signals in a wireless communication system, e.g., wireless signals comprising road traffic event data. In one example, the processor 1212 may be any of a selection of processing circuitry and/or a central processing unit and/or processor modules and/or multiple processors configured to cooperate with each-other. Further, the control arrangement 1200 may further comprise a memory 1215. The memory 1215 may contain instructions executable by the processor to perform any of the methods described herein. The memory and/or computer-readable storage medium referred to herein may comprise of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive. In some embodiments, the computer-readable medium may be a non-transitory computer-readable medium, such as a tangible electronic, magnetic, optical, infrared, electromagnetic, and/or semiconductor system, apparatus, and/or device.

In a further embodiment, the control arrangement 1200 may further comprise and/or be coupled to one or more sensors configured to e.g., receive and/or obtain and/or measure physical properties pertaining to the control arrangement 1200 or to the vehicle 100.

In one or more embodiments the control arrangement 1200 may further comprise an input device 1217, configured to receive input or indications from a user and send a user-input signal indicative of the user input or indications to the processor or processing means 1212.

In one or more embodiments the control arrangement 1200 may further comprise a display 1218 configured to receive a display signal indicative of rendered objects, such as text or graphical user input objects, from the processor or processing means 1212 and to display the received signal as objects, such as text or graphical user input objects.

In one embodiment the display 1218 is integrated with the user input device 1217 and is configured to receive a display signal indicative of rendered objects, such as text or graphical user input objects, from the processing means 1212 and to display the received signal as objects, such as text or graphical user input objects, and/or configured to receive input or indications from a user and send a user-input signal indicative of the user input or indications to the processing means 1212.

In embodiments, the processing means 1212 is communicatively coupled to a selection of any of the memory 1215 and/or the communications interface and/or transceiver and/or the input device 1217 and/or the display 1218 and/or the one or more sensors. In embodiments, the transceiver 1204 communicates using wired and/or wireless communication techniques. The wired or wireless communication techniques may comprise any of a CAN bus, Bluetooth, Wi-Fi, GSM, UMTS, LTE or LTE advanced communications network or any other wired or wireless communications network known in the art.

According to an aspect of the present disclosure, a control arrangement is provided, the control arrangement comprising:
a processor,
and a memory, said memory containing instructions executable by said processor, whereby said control arrangement CA is operative to perform any of the methods described herein.

According to a further aspect of the present disclosure a computer program comprising instructions which, when the program is executed by a computer, cause the computer to carry out the methods described herein.

According to a further aspect of the present disclosure a computer-readable medium is provided and comprises instructions which, when executed by a computer, cause the computer to carry out the methods described herein.

In embodiments, the communications network communicate using wired or wireless communication techniques that may include at least one of a Local Area Network (LAN), Metropolitan Area Network (MAN), Global System for Mobile Network (GSM), Enhanced Data GSM Environment (EDGE), Universal Mobile Telecommunications System, Long term evolution, High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi, Voice over Internet Protocol (VoIP), LTE Advanced, IEEE802.16m, Wireless MAN-Advanced, Evolved High-Speed Packet Access (HSPA+), 3GPP Long Term Evolution (LTE), Mobile WiMAX (IEEE 802.16e), Ultra Mobile Broadband (UMB) (formerly Evolution-Data Optimized (EV-DO) Rev. C), Fast Low-latency Access with Seamless Handoff Orthogonal Frequency Division Multiplexing (Flash-OFDM), High Capacity Spatial Division Multiple Access (iBurst®) and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX) and ultrasonic communication, etc., but is not limited thereto.

Moreover, it is realized by the skilled person that the control arrangement 1200 may comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, encoder, decoder, power supply units, power feeders, communication interfaces, communication protocols, etc. which are suitably arranged together for performing the present solution.

Especially, the processor and/or processing means of the present disclosure may comprise one or more instances of processing circuitry, processor modules and multiple processors configured to cooperate with each-other, Central Processing Unit (CPU), a processing unit, a processing circuit, a processor, an Application Specific Integrated Circuit (ASIC), a microprocessor, a Field-Programmable Gate Array (FPGA), an arithmetic logic unit (ALU), a digital signal processor, a microcomputer, a System-on-Chip (SoC), a programmable logic unit, a microprocessor, an application-specific integrated circuit, or any other device capable of electronically performing operations in a defined manner or other processing logic that may interpret and execute instructions. The expression “processor” and/or “processing means” may thus represent a processing circuitry comprising a plurality of processing circuits, such as, e.g., any, some or all the ones mentioned above. The processing means may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A method performed by a control arrangement configured to control an electrically powered vehicle, the method comprising:
determining a desired total braking force to act on one or more powertrains of the electrically powered vehicle;
estimating a first braking force indicative of an offered braking force to act on the one or more powertrains using characteristics of a power storage of the electrically powered vehicle and characteristics of a braking unit of the electrically powered vehicle;
evaluating when the first braking force is greater than the offered braking force, and if the evaluation is true, the method further comprising the steps:
controlling a first electric machine to generate a driving force acting on one of the one or more powertrains, the first electric machine being electrically coupled to the power storage; and
controlling the braking unit to generate a second braking force counteracting the driving force and acting on one of the one or more powertrains of the electrically powered vehicle.

2. The method of claim 1, wherein the characteristics of the power storage include a maximum momentary current that the power storage can receive, and wherein the characteristics of the braking unit include regenerative braking force, wherein estimating the first braking force comprises matching the maximum momentary current to a corresponding regenerative braking force using a predetermined relation.

3. The method according to claim 2, wherein the maximum momentary current that the power storage can receive is determined based on measurements of a selection of current sensors, voltage sensors and temperature sensors coupled to the power storage.

4. The method according to claim 3,
wherein the first electric machine is controlled to a first working point having a relatively low momentary braking force if a difference between the first braking force and the offered braking force is below a threshold value, or
wherein the first electric machine is controlled to a second working point having a relatively high momentary braking force if a difference between the first braking force and the offered braking force is equal to or above the threshold value.

5. The method according to claim 1, wherein the desired total braking force is determined based on output from an input device controlled by a user.

6. The method according to claim 1, wherein the desired total braking force is determined based on output from a vehicle navigation module, the output from the from vehicle navigation module comprising a first brake force profile over time, wherein the first brake force profile over time is predicted using vehicle route and map data by the navigation module.

7. The method according to claim 6, wherein the characteristics of the power storage further include state of change of the power storage, wherein the offered braking force comprises a second brake force profile over time derived using the state of change of the power storage, wherein evaluating when the desired total braking force is greater than the offered braking force comprises comparing the first brake force profile over time to the second brake force profile over time.

8. An electrically powered vehicle comprising:
one or more powertrains;
a power storage configured to store electrical energy, provide electrical energy, and receive electrical energy,
one or more sensors coupled to the power storage and configured to measure characteristics of the power storage;
a first electric machine configured to generate a driving force acting on at least one of the one or more powertrains, the first electric machine being electrically coupled to the power storage; and
a braking unit configured to generate a braking force counteracting the driving force and acting on at least one of the one or more powertrains; and
a control arrangement comprising a processor, and a memory, said memory containing instructions executable by said processor, wherein the control arrangement is communicatively coupled to the one or more sensors, the braking unit and the first electric machine, and wherein said control arrangement is operative to perform the method of:
determining a desired total braking force to act on one or more powertrains of the electrically powered vehicle;
estimating a first braking force indicative of an offered braking force to act on the one or more powertrains using characteristics of a power storage of the electrically powered vehicle and characteristics of a braking unit of the electrically powered vehicle;
evaluating when the first braking force is greater than the offered braking force, and if the evaluation is true, the method further comprising the steps:
controlling a first electric machine to generate a driving force acting on one of the one or more powertrains, the first electric machine being electrically coupled to the power storage; and
controlling the braking unit to generate a second braking force counteracting the driving force and acting on one of the one or more powertrains of the electrically powered vehicle.

9. The vehicle according to claim 8, wherein the braking unit comprises a second electric machine, the second electric machine being electrically coupled to the power storage.

10. The vehicle according to claim 8, wherein the braking unit comprises auxiliary brakes.

11. The vehicle according to claim 10, wherein the auxiliary brakes are selected from any one of exhaust brake, retarder, Compression Release Engine Brake.

12. The vehicle according to claim 8, wherein the first electric machine and the braking unit are configured to act on the same one of the one or more powertrains.

13. The vehicle according to claim 8, wherein the first electric machine and the braking unit are configured to act on different powertrains of the one or more powertrains.

14. A control arrangement configured to control an electrically powered vehicle, the control arrangement comprising:
a processor; and
a non-transitory memory, said memory containing instructions executable by said processor to thereby cause the processer to:
determine a desired total braking force to act on one or more powertrains of the electrically powered vehicle;
estimate a first braking force indicative of an offered braking force to act on the one or more powertrains using characteristics of a power storage of the electrically powered vehicle and characteristics of a braking unit of the electrically powered vehicle;
evaluate when the first braking force is greater than the offered braking force, and if the evaluation is true, the method further comprising the steps:
control a first electric machine to generate a driving force acting on one of the one or more powertrains, the first electric machine being electrically coupled to the power storage; and
control the braking unit to generate a second braking force counteracting the driving force and acting on one of the one or more powertrains of the electrically powered vehicle.

15. A computer program product stored on a non-transitory computer-readable medium, said computer program product for controlling an electrically powered vehicle, wherein said computer program product comprising computer instructions to cause one or more processors to:
determine a desired total braking force to act on one or more powertrains of the electrically powered vehicle;
estimate a first braking force indicative of an offered braking force to act on the one or more powertrains using characteristics of a power storage of the electrically powered vehicle and characteristics of a braking unit of the electrically powered vehicle;
evaluate when the first braking force is greater than the offered braking force, and if the evaluation is true, the method further comprising the steps:
control a first electric machine to generate a driving force acting on one of the one or more powertrains, the first electric machine being electrically coupled to the power storage; and
control the braking unit to generate a second braking force counteracting the driving force and acting on one of the one or more powertrains of the electrically powered vehicle.

16. (canceled)
